(19) United States
(12) Patent Application Publication
(10) Pub. No.: US 2015/0286725 A1
(43) Pub. Date: Oct. 8, 2015

(54) SYSTEMS AND/OR METHODS FOR STRUCTURING BIG DATA BASED UPON USER-SUBMITTED DATA ANALYZING PROGRAMS

(71) Applicant: Zillabyte, Inc., San Francisco, CA (US)

(72) Inventor: Jacob Quist, San Francisco, CA (US)

(21) Appl. No.: 14/596,734

(22) Filed: Jan. 14, 2015

Related U.S. Application Data
(60) Provisional application No. 61/974,524, filed on Apr. 3, 2014.
(60) Provisional application No. 62/010,649, filed on Jun. 11, 2014.

(51) Int. Cl. G06F 17/30; G06F 9/54

(52) U.S. Cl. CPC G06F 17/30864; G06F 9/54

(57) ABSTRACT

Certain examples described herein relate to techniques for structuring large information repositories such as, for example, big data such as a web-scale crawled copy of the web and other large data repositories based upon user-provided analyzing programs, and/or responding to such analyzing programs. Techniques may include operations providing a data processing and analyzing platform including access to one or more data sources; receiving a data analyzing program submitted by a first user; executing the received data analyzing program on the data processing and analyzing platform; adding at least a portion of the data analyzing program to the data processing and analyzing platform such that the added at least a portion of the data analyzing program is usable by other users; and returning a result to the first user as a response to the submitted data analyzing program.

### CROSS-REFERENCE TO RELATED APPLICATION

This application claims the benefit of U.S. Provisional Patent Application No. 61/974,524 filed on Apr. 3, 2014, and U.S. Provisional Patent Application No. 62/010,649 filed on Jun. 12, 2014, each of which is hereby incorporated herein by reference in its entirety.

### TECHNICAL FIELD

Certain example embodiments described herein relate to techniques for data processing and analysis in large information systems that include access to big data. More particularly, certain example embodiments relate to techniques for structuring large-scale data corpora using data analyzing programs submitted by users.

### BACKGROUND AND SUMMARY OF CERTAIN EXAMPLE EMBODIMENTS

The amount of digitally stored information is immense, and continues to grow at even higher rates as data storage becomes less expensive and as day-to-day activities increasingly are performed online. As the amount of data and the number of data sources keep increasing, however, the ability to find desired information may not get any easier.

Search tools like that from Google™ use powerful algorithms to organize the massive amounts of data available on the web. For example, the so-called “PageRank” algorithm ranks a web page based upon criteria including a measure of how many other web pages link to them. Other web page ranking algorithms include those that relate the relevance of a web page to a particular keyword by measuring the density of that keyword in that web page. Consequently, however, the information presented by the various search engines to users in response to their queries is found and indexed in accordance with whatever the algorithms or techniques used by those search engines.

Although conventional search engines can access the so-called “world's information” (i.e., information accessible on the world wide web and/or other large global network), to the extent that any information is accessible on a public network, the ability to query such information is limited to single key words, single phrases, or simple combinations of key words and phrases.

Although more complex querying can be performed on smaller databases (e.g., corporate databases and other systems supported by relational database systems, for example), such flexibility is not available for querying and/or analyzing so called “big data” such as web-scale data troves and/or infinite data streams that are network reachable. The term big data refers to massive data collections that are, in general, beyond the capabilities of database systems such as, for example, commercially-available relational database systems. A web-scale (e.g. 2 billion web pages) collection of raw web data and infinite data streams such as Twitter™ or blog feeds are examples of big data.

According to Wikipedia (http://en.wikipedia.org/wiki/Big_data), a report by Gartner Corporation defines big data as “high volume, high velocity, and/or high variety information assets that require new forms of processing to enable enhanced decision making, insight discovery and process optimization”. Also according to Wikipedia, big data includes large volume unstructured data which cannot be handled by standard database management systems like DBMS, Relational DBMS or Object Relational DBMS. Moreover, big data sizes are a constantly moving target as of 2012 ranging from a few dozen terabytes to many petabytes of data in a single data set.

Hadoop™ is a framework for using big data. Frameworks such as Hadoop™ are designed for accessing large data sources, and offer more flexibility than traditional data warehousing frameworks. However, Hadoop infrastructure is difficult to deploy, and, in order to obtain results from the data to which Hadoop has access to, programs are typically written in languages such as Java rather than more modem software development frameworks such as Ruby, Python and Java Script etc. Moreover, Hadoop does not provide for sharing code between unrelated users (e.g., users unrelated by administrative domain etc.).

Certain example embodiments disclosed herein address these and/or other concerns. For instance, certain example embodiments disclosed herein provide for structuring large information troves using crowd-sourced data analyzing programs. An example method embodiment includes providing a data processing and analyzing platform including access to one or more big data sources, receiving a data analyzing program submitted by a first user, executing the received data analyzing program on the data processing and analyzing platform, adding at least a portion of the data analyzing program to the data processing and analyzing platform such that the added at least a portion of the data analyzing program is usable by other users, including users unrelated to the first user (e.g., users in different administration domains from the first user) and returning a result to the first user as a response to the submitted data analyzing program.

A first data source from the one or more data sources may include raw web data and/or an infinite data stream, and the executing may include accessing the raw web data and/or the infinite data stream.

The raw web data in the first data source may be acquired by pre-crawling the web, where pre-crawling includes scraping data from each web page by a web crawler.

The first data source may comprise a web-scale copy of the web as captured by a plurality of web crawlers.

The method may also include receiving a second data analyzing program from one of said other users, and executing the second data analyzing program on the data processing and analyzing platform. The executing of the second analyzing program includes accessing an added portion of the data analyzing program.

The method embodiment may include adding at least a portion of the result to the data processing and analyzing platform as another data source accessible to the other users.

The method embodiment may further include receiving a second data analyzing program from one of the other users, and executing the second data analyzing program by accessing at least the added another data source.

The second data analyzing program may include one or more statements referring to a structure of said another data source, and the structure may be in accordance with the data analyzing program submitted by the first user.

In some method embodiments, the added another data source is substantially concurrently being updated by the first data analyzing program submitted by the first user while a second analyzing program accesses it.

The method may also include providing an application programming interface (API) for accessing operations of the data processing and analyzing platform. The data processing query may incorporate at least portions of the API.

Providing an API may include configuring the API to include information regarding the one or more data sources, configuring the API to display the information regarding the one or more data sources to users, etc.

The executing may include parsing the received data analyzing program, generating a plurality of sub-programs based upon the parsed data analyzing program, scalably executing the plurality of sub-programs across a plurality of computers, and combining outputs from the sub-programs to generate the result.

The method may also include continuing to update said data source after the returning based upon changes in the one or more data sources and the received data analyzing program, monitoring said data source for updates, and notifying the user when the monitoring detects an update.

An example system embodiment includes a plurality of data sources including one or more big data sources, and a processing system including at least one processor. The processing system is configured to access said plurality of data sources. The processing system is also configured to: provide a data processing and analyzing platform including access to one or more data sources, receive a data analyzing program submitted by a first user, execute the received data analyzing program on the data processing and analyzing platform, add at least a portion of the data analyzing program to the data processing and analyzing platform such that the added at least the portion of the data analyzing program is usable by other users, and return the result to the first user as a response to the submitted data analyzing program.

The one or more big data sources in the system may include a raw web data and/or an infinite data stream.

The raw data sources may include a web-scale crawled copy of the web.

The processing system may be further configured to receive a second data analyzing program from one of said other users, and to execute the second data analyzing program on the data processing and analyzing platform. The executing of the second analyzing program may include accessing the added at least a portion of the first data analyzing program.

The system may include an application programming interface (API) for providing user-provided analyzing programs to access the data processing and analyzing platform.

A non-transitory computer readable storage medium embodiment includes instructions stored thereon that, when executed by a computer, causes the computer to perform operations including providing a data processing and analyzing platform including access to one or more data sources including big data, receiving a data analyzing program submitted by a first user, executing the received data analyzing program on the data processing and analyzing platform, adding at least a portion of the first data analyzing program to the data processing and analyzing platform such that the added at least a portion of the first data analyzing program is usable by other users, and returning the result to the user as a response to the submitted data analyzing program.

The computer medium embodiment may also include providing access to a web-scale crawled copy of the web and/or an infinite data stream.

These aspects, features, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a simplified schematic view of a data processing and analyzing system and its environments, in accordance with one or more embodiments;

FIG. 2 illustrates a flowchart of a method for structuring and processing information including big data, in accordance with one or more embodiments;

FIG. 3 illustrates an outline of a user-provided data program using a “spout from relation” operation, in accordance with certain example embodiments;

FIG. 4 illustrates an outline of a user-provided data program using a “function/each” operation, in accordance with certain example embodiments;

FIG. 5 illustrates an outline of a user-provided data program using a “group” operation, in accordance with certain example embodiments;

FIG. 6 illustrates an outline of a user-provided data program using a “join” operation, in accordance with certain example embodiments;

FIG. 7 illustrates an outline of a user-provided data program using a “sink” operation, in accordance with certain example embodiments;

FIG. 8 illustrates a relation optimization technique according to some embodiments;

FIG. 9 illustrates a flowchart of a method for a user to structure an information store and analyze data including big data, in accordance with one or more embodiments;

FIG. 10 illustrates a flowchart of a method for executing the user-provided data analyzing programs in the data processing and analyzing platform, in accordance with one or more embodiments;

FIG. 11 illustrates some components in a memory of a computer configured according to cause an embodiment to operate as a data processing and analyzing platform server and/or data processing and analyzing execution node;

FIG. 12 illustrates an example outline of a user-provided data analyzing program, according to an embodiment, that can be used for finding restaurants that sell pumpkin pie; and

FIG. 13 illustrates an example outline of a user-provided data analyzing program, according to an embodiment, that can be used for correlating the information from the web and the patent corpus in order to deliver information requested by the startup company.

### DETAILED DESCRIPTION OF CERTAIN EXAMPLE EMBODIMENTS

Certain example embodiments relate to techniques for using user-provided programs to structure a large data collection comprising one or more data corpuses. The example embodiments disclosed herein may apply to any scenario that involves data corpuses accessed by users including, for example, extremely large scale corpuses. Certain example embodiments are particularly beneficial when the data corpuses include raw (e.g., unstructured) data and/or very large (e.g., web-scale) data corpuses such as data referred to as big data. The example embodiments may also be particularly beneficial in environments where a large number of users access the data corpuses to search for information so that large numbers of user programs will quickly be available to structure large portions of the data corpuses.

Certain example embodiments overcome many disadvantages of conventional search engines and database systems. For example, in contrast to conventional search engines and database systems, certain example embodiments enable users to structure large troves of information using queries. By enabling large numbers of users to query a large trove of information, a substantial part of the structuring of that data may be advantageously crowd-sourced.

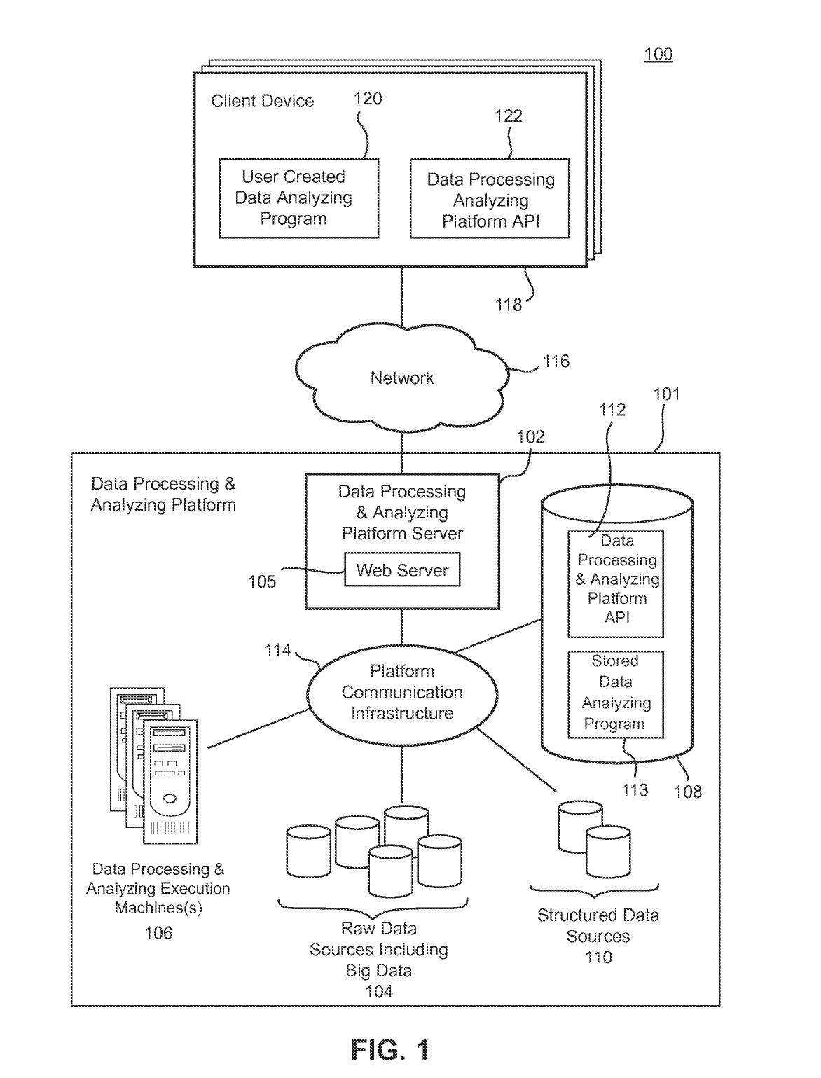

Certain example embodiments provide for capturing the world's information into a single location by, for example, storing a crawled copy of the web on a local cluster of machines. The stored copy of the web may be used by users who derive value from making decisions based on the state of the world's information. For example, marketing companies as users may use a data processing and analyzing platform, such as that described in relation to FIG. 1 below, in connection with the stored copy of the web to understand where their ideal customers are. Economists may use such a data platform and stored data to understand correlations between securities and the web. Another example is the legal community, who can build focused algorithms to extract exactly the desired information from troves of legal documents stored throughout the web.

An example user may be a developer at a marketing company who is tasked with finding all the restaurants that sell pumpkin-pie in United States. The information may be for market research, and also as a potential lead list for an upcoming marketing campaign. A search on any of the current search engines would return any and all web pages that have whatever the keywords provided by the developer and, when considered for the entire web (or a large part of the web), would return numerous web pages that are of no relevance to the developer.

The developer, based on personal knowledge that many restaurants publish their menus online, may desire to write an algorithm that searches for all online menus and to identify menus that have the term “pumpkin pie”. But even if the developer has a good algorithm (e.g., a natural language processing technique to identify from a web page whether a restaurant actually sells “pumpkin pie” with high reliability), conventional search engines and other systems do not provide for such analysis. With only conventional systems, the developer may have to first run a web crawler to scrape every restaurant website on the web. But, in the absence of a list of all restaurants and their websites, the developer's web crawler may have to crawl the entire web to find this information. Having to crawl the entire web, or even a substantial part of the web, in real-time in response to such queries is often neither scalable nor practical.

Another example user is an entrepreneur who wants to start a new business that will notify its clients whenever a startup company submits a new patent application. The patent application information of interest can at least in theory be obtained from the patent corpus available at the United States Patents and Trademark Office web servers. But because patent applications do not typically describe a company's size (e.g., startup or Fortune 500), the entrepreneur effectively needs to make associations between the patent corpus and a database, such as CrunchBase™, which does contain a field for the company size. Conventional search engines thus cannot conveniently yield the results sought by the entrepreneur.

By contrast, certain example embodiments provide for addressing the desires and/or requirements of the developer user and the entrepreneur user discussed above in a real-time, scalable, and user-friendly manner. Using the example techniques set forth herein, for example, the developer user can submit a query to obtain from the web a list of restaurants that sell pumpkin pie. Similarly, the entrepreneur user can use the user-provided query to access patent data from the patent corpus and then relate to the corresponding corporation data in another database.

Certain example embodiments may provide for accelerating the query process for large scale data repositories so that the users can obtain query results in a substantially faster manner than batch-based implementations, and, in some embodiments, in real time. Batch-based implementations such as many big data systems (including, for example, Hadoop™) can take several hours (and possibly even days) to complete a query of only moderate complexity. However, real time aspects introduce many challenges. One of the most notable challenges is in aggregation. Whereas in conventional Hadoop systems aggregation is relatively easily achievable because there is a well-defined start and end to all aggregate groupings, this is not necessarily the case in real time streaming systems. For example, suppose one wanted to count the number of words from an infinite data stream such as the Twitter stream: The moment counting is finished, a new batch or stream may be created, and the previous aggregation is now wrong. Certain example embodiments may use “cycles”—with a cycle being a user-defined start and end to a stream of data—to help address this condition.

Certain example embodiments also provide for a high level of scalability based primarily upon horizontal scaling. At least in some embodiments, the data processing and analyzing platform is configured to capture the state of the entire world, e.g., by making a copy of substantially all reachable web pages on local servers (e.g., a web-scale copy). Thus, because the amount of data in such data stores is expected to rapidly increase, the data processing and analyzing platform may be configured to scale by simply adding more machines to achieve so-called “horizontal scaling”. In some embodiments, however, the data processing and analyzing platform is configured also for vertical scaling (e.g., replacing at least some servers with higher capacity servers).

Scalability is also relevant in handling relational data. Much of the structured data is relational, but a drawback of relational data is that it is very difficult to scale. Most of the big data systems are built on simple key-value stores that can easily scale to multiple machines. Relational data oftentimes is seen as being more difficult to scale because the data is highly interconnected. Some embodiments include techniques for scaling relational data.

A low-complexity user interface is one tool useful in helping to ensure that a sufficiently large number of users willingly interact with the query features provided by at least some embodiments. Low-complexity interfaces often result in high user friendliness. Thus, users can focus on what they care about, which typically involves building their algorithms (e.g., the business aspect and/or the business problems to be addressed by the algorithm), without being burdened with optimizing for scaling, etc. In certain embodiments, user friendliness is improved by allowing users to submit their data processing queries in any of a plurality of languages without restricting them to one platform specific language. This allows users to work with tools with which they are already familiar.

FIG. 1 is a simplified schematic view of a data processing and analyzing system 100 in accordance with one or more embodiments. System 100 may include a data processing and analyzing platform 101, one or more client devices 118 and a network 116 providing communication connectivity between the platform 101 and client device(s) 118.

Platform 101 may operate to structure information in accordance with user-provided data analyzing programs. According to an embodiment, when platform 101 includes a substantial pre-crawled copy of the web (i.e., the world wide web), users may submit programs (also sometimes referred to herein as “flows” or “data analyzing programs”) to query the world's information according to a structure and arrangement specified by the user. The structure(s) created in response to the user-provided data query

ing programs are, in addition to being returned to the respective users, also added to platform 101 as new data sources. Thus, platform 101 provides for crowd-sourcing the structuring of large-scale data such as, but not limited to, web data. Certain example embodiments are particularly advantageous when data sources include sources that are web-scale in the volume of data. The term “web-scale” refers to a volume of data including web-pages and/or other information content collected from, searched for and/or accessed at locations distributed throughout a vast part of the web (e.g., about two billion web pages accessible from the public internet).

Platform 101 includes a data processing and analyzing platform server 102, raw data source(s) 104, data processing and analyzing execution machines 106, one or more storage devices 108 including a data processing and analyzing platform application programming interface (API) 112, stored data analyzing programs 113, structured data source(s) 110, and a platform communication infrastructure 114 providing interconnectivity between components of the data processing and analyzing platform 101.

Platform server 102 may include one or more computers and operates to provide an interface between platform 101 and users. Platform server 102 may include and/or have access to a plurality of storage devices which store one or more data corpuses (e.g., raw data sources 104 and/or structured data source 110). Platform server 102 may also operate to interface with external data sources (e.g., for receiving updates to copies of data stored locally). Platform server 102 may also include a web server 105 to handle incoming web requests.

Raw data sources 104 include raw data obtained from one or more sources. Raw data may include data obtained by crawling the web. For example, raw data sources 104 may include stored web crawler output where the web crawler scrapes the content of each web page reachable on the internet. Other examples of raw data sources 104 may include a patent corpus, a Twitter stream corpus, a blog stream, and/or other raw data obtainable from various sources. The term “raw data” is used herein to refer to unstructured data, in contrast to data that is explicitly structured (e.g., in relational form), such as structured data sources 110.

In some embodiments, the largest and most well known (and therefore, most frequently used by users) data corpus in the data processing and analyzing platform is the web corpus. The web corpus is, in some embodiments, a large copy of the web that web crawlers have previously crawled. Although the bulk of the web corpus may be pre-crawled, the corpus may be updated in real-time or in near real-time with respect to updates occurring ob the corresponding live sources. However, the data processing and analyzing platform, in at least some embodiments, is a generalized system, and is not specifically built only for web crawling or storing web pages, but provides a framework that allows users to submit their own programs, which may include web crawlers.

Structured data sources 110 include structured data, such as, for example, the data generated in response to user-provided data analyzing programs. The data generated in response to user-provided data analyzing programs may include an explicit structure, such as, for example, a relation represented as a table of one or more columns Structured data sources 110 may include structured data generated in response to user-provided data analyzing programs, and may also include other structured data (e.g., data that was structured by entities other than user).

Data storage 108 may include an API 112 for the data processing and analyzing platform. The API 112, or references to portions thereof, can be incorporated in the user-provided data analyzing programs so that those programs can correctly receive data from the data sources of the data processing and analyzing platform. For example, API 112 may provide a client line interface (CLI) that may be downloaded to the client devices to provide a terminal-like interface in which the user-provided queries can be submitted for execution on the data processing and analyzing platform and where results can be received.

Stored data analyzing programs 113 include data analyzing programs submitted by users. In some instances, portions of data analyzing programs submitted by users may be saved in a memory and/or other storage of the platform 101 in stored data analyzing programs 113.

Data processing query execution machines 106 may include one or more servers that are used for executing the user-provided data analyzing programs. As will be described below, some embodiments include executing the same user-provided data analyzing program (or parts thereof) simultaneously (or substantially simultaneously) on multiple machines in order to execute the queries over very large data corpora in a scalable manner, and then combining the results generated on respective machines or group of machines.

The server 102, raw data sources 104, data processing and analyzing execution machines 106, data storage 108, structured data sources 110, and communication infrastructure 114 may be arranged in numerous ways to form the data processing and analyzing platform 101. For example, any combination of server 102, raw data sources 104, execution machines 106, structured data sources 110 and data storage 108 may be in a single computer and/or group of servers. Moreover any combination of server 102, raw data sources 104, execution machines 106, structured data sources 110 and data storage 108 may be distributed at different locations (e.g., be located in the cloud) and may be interconnected to the rest of the platform 101 through communication infrastructure 114.

Communication infrastructure 114 may include one or more communication networks and/or internal communication structures for servers, or storage systems. Network 116 may include one or more local area networks, wide area networks, and/or internet. In some embodiments, such as when platform 101 is distributed over network 116 (e.g., located in the cloud), at least a part of the communication infrastructure 114 may operate over network 116.

A client device 118 that interacts with data processing and analyzing platform 101 may include one or more user-provided data analyzing programs 120 and at least a portion 122 of the data processing and analyzing platform API 112. Client device 118 may communicate with the platform 101 over a network, such as the internet, in order to submit data processing queries for execution on the data processing and analyzing platform 101 and to obtain results to its queries. Such communication with the data processing and analyzing platform 101 can be performed, for example, using a CLI interface provided with the data processing and analyzing platform API.

Client device 118 may also include one or more data analyzing programs, constructed in accordance with the data processing and analyzing platform API 112. The data analyzing programs may be stored locally on the respective client devices, and subsequently submitted to the platform 101.

System 100 may also include one or more web-crawlers or the like (not shown) that are deployed throughout network 116 to continuously update raw data sources 104 based upon updates to corresponding original web pages. System 100 may also include one or more other modules (not shown) that update raw data sources 104 in accordance with continuously occurring updates to one or more infinite data streams.

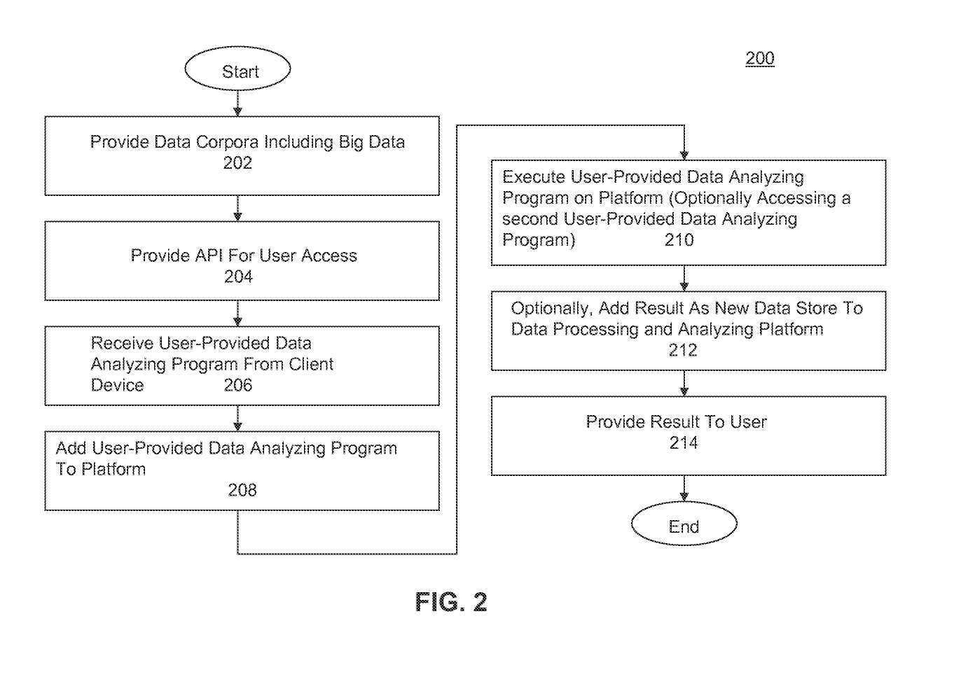

FIG. 2 illustrates a flowchart of a method 200 for structuring and processing information, in accordance with one or more embodiments. Operations 202-214 may be performed in performed, for example, by the data processing and analyzing platform 101. It will be understood that operations 202-214 may be performed in the order shown, in an order other than shown, without one or more operations 202-214, or with one or more additional operations.

At operation 202, the data processing and analyzing platform 101 provides data corpuses including big data. Data corpuses provided may include raw data corpuses and structured data corpuses. Raw data corpuses may include a copy (e.g., a copy of all web pages acquired by one or more web crawlers) of the web. Other raw data corpuses may include a patent corpus, social media corpuses (e.g., Facebook™, Twitter, etc.), and other unstructured or substantially unstructured data corpora.

Structured corpora include data obtained from user-provided data processing queries already executed on the data processing and analyzing platform. For example, the results output by respective user-provided data analyzing programs are added to the structured corpora. Structured corpora may also include other databases that are already structured such as, for example, relational databases.

At operation 204, platform 101 provides for API access by users. Providing API access may include providing the API to client devices. The API provides an interface to the user into the data processing and analyzing platform 101. According to an embodiment, the API includes a command line interface (CLI) that is downloadable to the client device(s) from a server of the data processing and analyzing platform. The API may also include other functions to interact with the data processing and analyzing platform. For example, in some embodiments the API may include a query interface, a data processing query upload interface, an interface to obtain a listing of data sources etc.

At operation 206, a user-provided data analyzing program is received from a client device. The data analyzing program comprises an algorithm that may be written by the user customized for his data needs. The data analyzing program provides for accessing data from one or more sources and processing the data using various operations such as, but not limited to, filtering, selecting, grouping, changing, rearranging, etc., before generating a response. However, the API or the data processing and analyzing platform, may impose restrictions on the form of the data analyzing program. In some embodiments, the user-provided data analyzing programs are required to adhere to the so-called “pipe paradigm”. Data analyzing programs formed according to the “pipe paradigm” lend themselves better (e.g., when compared to queries written without adhering to the pipe paradigm) for highly scalable execution.

The “pipe paradigm” programming model is popular in big data systems (e.g., in Cascading, Storm, etc.). The pipe paradigm enables the output of a first function or query to be sent to another function or query as input. Programs written in accordance with the pipe paradigm minimize or entirely eliminate the use of explicit loops and the referencing of shared state from within loops, in order to facilitate scalability and reusability of the code. The pipe paradigm enables the developer to manipulate pipes of streaming data, and has a few primitive operations, such as, but not limited to, mapping, grouping, and joining.

Mapping refers to a map operation that reads a record from a pipe, does some processing on it in isolation (e.g., operate without looking at any other data in the pipe), and emits no records or one or more records. Mapping operations are desirable because they can be highly parallelized.

A user may desire to group records together and operate on them in aggregate. This could include, for example, analyzing a collection of web pages that belong to a given domain (e.g., zillabyte.com). Grouping typically is an expensive operation because all grouping keys are collected before subsequent operations may start.

Similar to grouping, it is often desirable to join two or more pipes together. The underlying techniques for joining may be similar to some extent to grouping. Like grouping, joining may also be a computationally expensive operation.

The data processing and analyzing platform 101 and the API provide several processing activities such as, for example, spout, spout-from-relation, function/each, group, join, and sink, that can be included in the user-provided data processing queries.

A “spout” processing activity is, in some embodiments, what produces data into a data analyzing program. All data analyzing programs are required to have at least one spout. A spout does not have any explicitly specified input (e.g., at least, no explicitly provided input from the data processing and analyzing platform) and simply emits records. According to an embodiment, a web-crawler may be connected as a spout to an active data analyzing program. The spout may independently find, for example, web pages to fetch, analyze, and emit records to downstream operations. According to some embodiments, every user-provided data analyzing program is required to have at least one spout.

Many use-cases for the data processing and analyzing platform 101 rely on consuming data that already exists in the data processing system 100 ecosystem. For example, data processing and analyzing platform 101 has a pre-crawled copy of the web. Rather than force users to reinvent the wheel and crawl the web in their spouts, embodiments allow users to “spout-from-a-relation” in the data processing queries. That is, the user may dictate what kind of data their spout consumes in a program and/or query such as a Structured Query Language (SQL-reducible query.

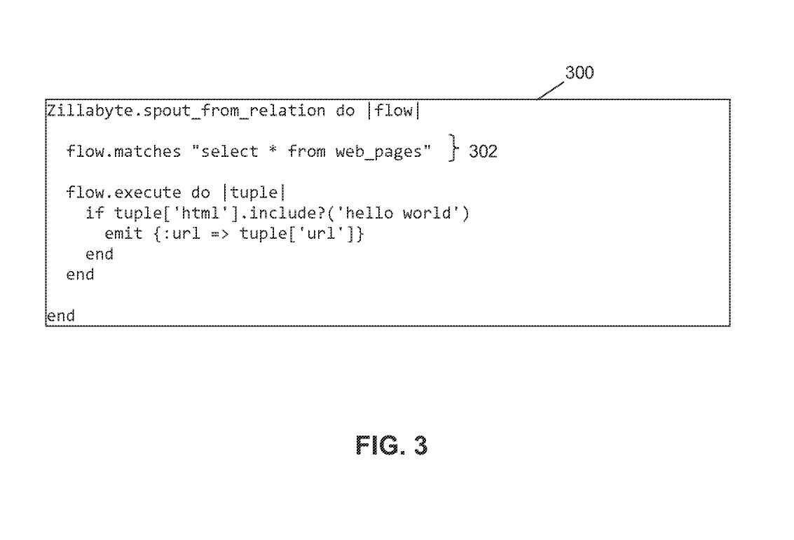

FIG. 3 illustrates an example user-provided data analyzing program 300 according to an embodiment. The example data analyzing program 300 can be used to determine which web pages have the term ‘hello world’ on it using the data processing and analyzing platform 101.

The ‘flow.matches “select * from web_pages”’ statement 302 in analyzing program 300 provides for analyzing program 300 to read all data elements of the web_pages corpus. For instance, in example analyzing program 300 all web pages from the locally stored copy of the web (e.g., web corpus) are streamed to analyzing program 300. The “matches” clause can be thought of, at a high level, as a SQL statement from which the spout and/or data analyzing program can read.

Example data analyzing program 300 thus receives a stream of web pages, and, for every web page that includes the phrase “hello world” outputs (e.g., emits) its URL (uniform resource locator).

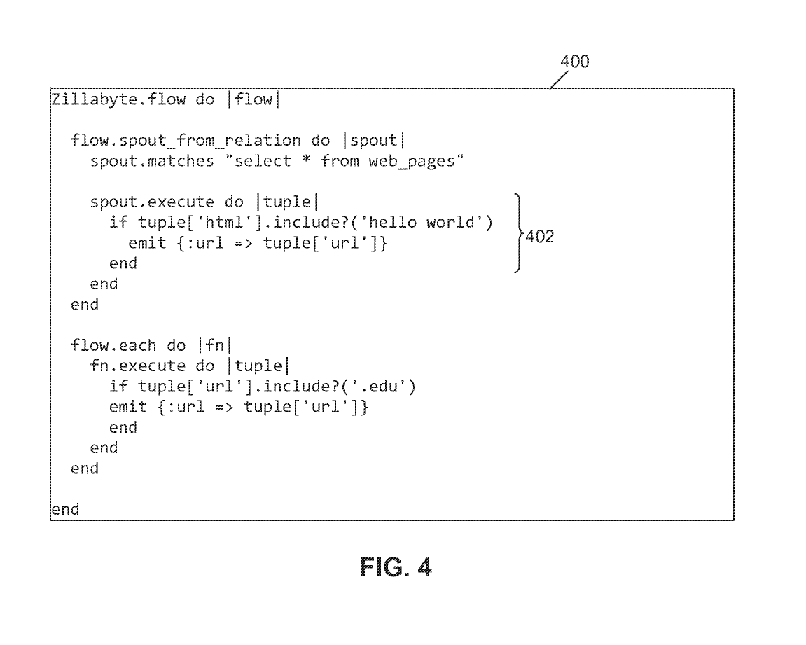

A function operation may be considered as being similar to a mapper in Hadoop, for example, in the MapReduce framework of Hadoop. That is, it consumes one record, analyzes and/or processes it, and emits zero or one or more new records. FIG. 4 illustrates an example user-provided data analyzing program 400 that enhanced analyzing program 300 so that only the URLs that have an ‘.edu’ (e.g., stanford.edu) are emitted.

One skilled in the art will appreciate that the logic associated with the use of ‘each’ in example data analyzing program 400, may have, in another example embodiment, been included with the ‘spout’ code segment 402 with substantially similar effect. The ‘each’ operation may be highly useful in aggregating and joining streams.

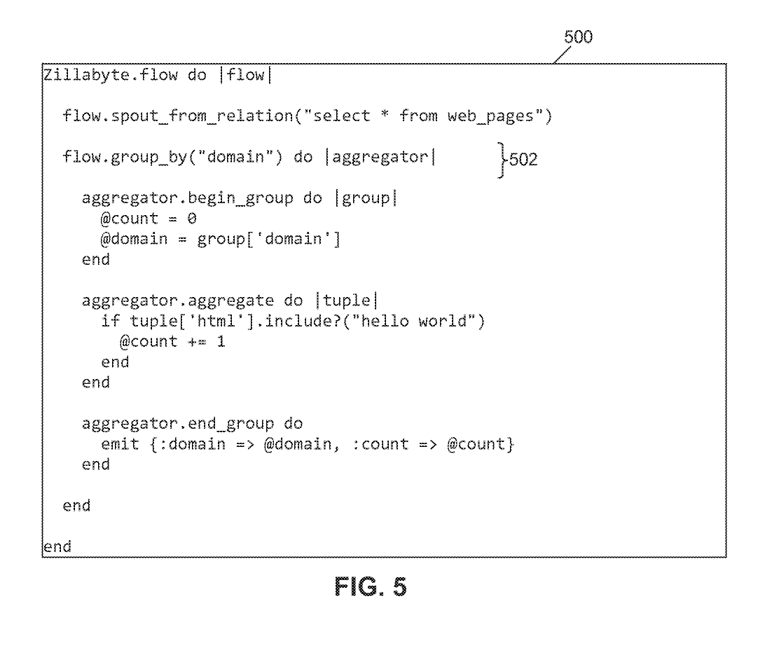

FIG. 5 illustrates an example user-provided data analyzing program 500. The “group_by” (502) provides for grouping records arriving on a single stream. Example data analyzing program 500 operates to count the occurrences of “hello world” in web pages from a specified domain, and emit a stream of tuples (e.g., key/value pair) such as “[zillabyte.com, 3] [google.com, 39] . . . ”

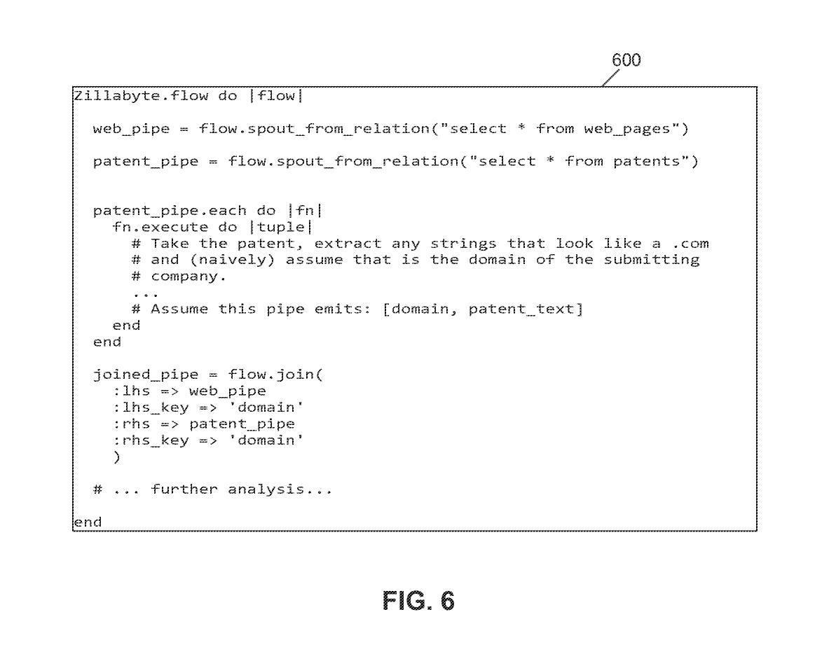

FIG. 6 illustrates the use of a joiner operation. Example user-provided analyzing program 600 shown in FIG. 6 operates to join two streams. Specifically, example analyzing program 600 receives a stream of web pages and a stream of patents, and joins the two streams based upon a domain determinable from the respective received web pages.

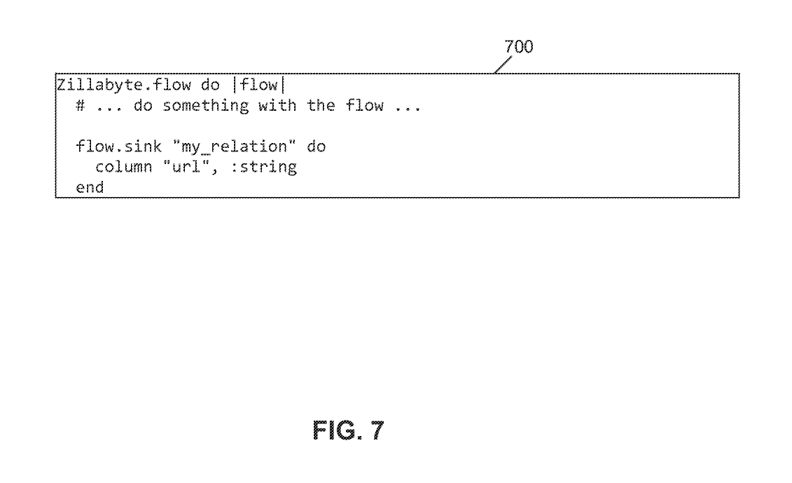

FIG. 7 illustrates a sink. All flows must end, and the terminal of a pipe is the sink. A sink will take the incoming tuples and put them into a relation in data processing framework 101. A sink takes a few parameters: (a) the name of the relation to sink to, and (b) one or more columns of the relation. The user specifies the type and name of the column.

Returning to method 200 shown in FIG. 2, at operation 208, the user-provided data analyzing program is prepared for execution on the data processing and analyzing platform 101. The preparation, in some embodiments, may include translation of user-provided code into a code runnable on the data processing and analyzing platform, incorporating additional program modules and/or code to be executed with the user-provided data analyzing program, optimizing the code of the user-provided data analyzing program, etc. The additional modules and/or code may include pre-built function libraries and/or data analyzing programs or parts of data analyzing programs previously submitted by this or other users, for example, in the course of using the data processing and analyzing platform to obtain results in response to one or more queries. The other users may include users who are not of the same administrative domain as the current user. For example, in some embodiments, any user accessing the data processing and analyzing platform may have his data analyzing program use and/or integrate components from previously submitted by himself or any other user. The additional program modules and/or code may be incorporated by either including such modules in the code for the user-provided data analyzing program, by referencing such modules, or by using data provided by the execution of such modules.

The preparation may also include storing the entire data analyzing program provided by the current user or at least a part thereof in a storage of the data processing and analyzing platform. For example, one or more parts of the data analyzing program provided by the current user can be saved where the parts are code segments, or themselves data analyzing programs, that provide a service that may be used by other data analyzing programs executing on the data processing and analyzing platform in the future. These code segments or modules may be identified in the data analyzing program in any manner. According to an embodiment, such code is identified based upon markers (e.g. keywords placed at the beginning and end of the code segment or module), for example, as specified in the API, placed in the code of a user-provided data analyzing program. Alternatively, they are identified by simply assigning a serial-id each time the program is submitted to the API.

An example may illustrate how a data analyzing program submitted by a user may incorporate and/or use other program components submitted by other users. Consider, for example, a program A submitted by a first user and one or more programs B submitted by a second user or second users, who may be unrelated to the first user. Programs B may, for example, perform complex analysis functions such as crawling (e.g., on the fly) the entire web for certain key words etc. and stream its output, or run complex algorithms for analyzing an incoming stream of data, etc. Because, in embodiments, programs A and B are written in accordance with the pipe-paradigm, they each can be conceptualized as a graph that has zero to many inputs nodes and zero to many output nodes. Each of these nodes defines a schema about what kind of data it expects as input and emits as output. In essence, when a program B is embedded or incorporated in another program A, the corresponding graphs are spliced together and a new super-graph of the conjoined programs is formed. In certain embodiments, a server-side repository for submitting user programs components for sharing, an enforcing of a pipe-paradigm in submitted programs which requires users to define the inputs & outputs of each program such that they can be interoperated automatically, and a server-side compilation process that can recursively splice programs together, provide the features described above.

Thus, unlike in conventional systems, the incorporation of program components in embodiments all of the injection happens automatically (e.g. handled by the data processing and analysis platform without human involvement). Moreover, in further contrast to conventional systems, when incorporating a second program within a first program, embodiments create a new data-processing pipeline across a distributed computing environment such that the output of one program's operation is fed (e.g., automatically) into the input of another program's operation. In contrast, conventional systems such as Hadoop compile programs on clients by the submitting users, rather than automatically on the servers.

At operation 210, the user-provided data analyzing program is executed on the data processing and analyzing platform 101. Persons of skill in the art will appreciate that the executed program would include code segments corresponding to the data analyzing program provided by the user, but may, at least in some instances, include additional code such as that which may have been incorporated at operation 208 discussed above. The data analyzing program may access data sources including raw data sources and/or structured data sources at the data processing and analyzing platform. Execution may also include scalably executing portions of the task on separate machines and subsequently combining the results. In embodiments, the components including the additional code can be written in other languages, submitted by other users. Such combining of code and/or components written in different languages is different from conventional systems which include a Java-only implementation. The data analyzing program, in some embodiments, is required by the data processing and analyzing platform to be in the form of input, processing, and output results. In contrast to conventional systems, in embodiments the data analyzing program may also be scaled at runtime. That is, the data processing and analysis platform according to some embodiments can increase the number of nodes a data processing and analyzing program is executing “on the fly”, while conventional systems such as Hadoop require the user to specify the number of nodes before invocation.

Another key difference between some embodiments and conventional systems such as Hadoop is that while Hadoop assumes all of the data exists permanently on the machine nodes, some embodiments only use machines for processing, and data is streamed over the network. This allows embodiments to handle realtime/streaming data, which is the bane of many conventional systems such as Hadoop.

The data processing and analyzing platform operates to execute the user-provided analyzing programs (sometimes referred to as “flows”). The data processing and analyzing platform directs large streams of data from data sources, such as structured (e.g., relational) data sources or raw data sources, to feed into user-provided queries, executes the user-provided queries using the streamed data, and then directs the output data from those data processing queries back into data stores as, for example, a relational structure.

At operation 212, optionally, the results produced by the executed data analyzing program are stored in the data processing and analyzing platform as one or more new data sources. According to at least some embodiments, the newly added data source may be accessed by user-provided analyzing program that are subsequently executed on the data processing and analyzing platform.

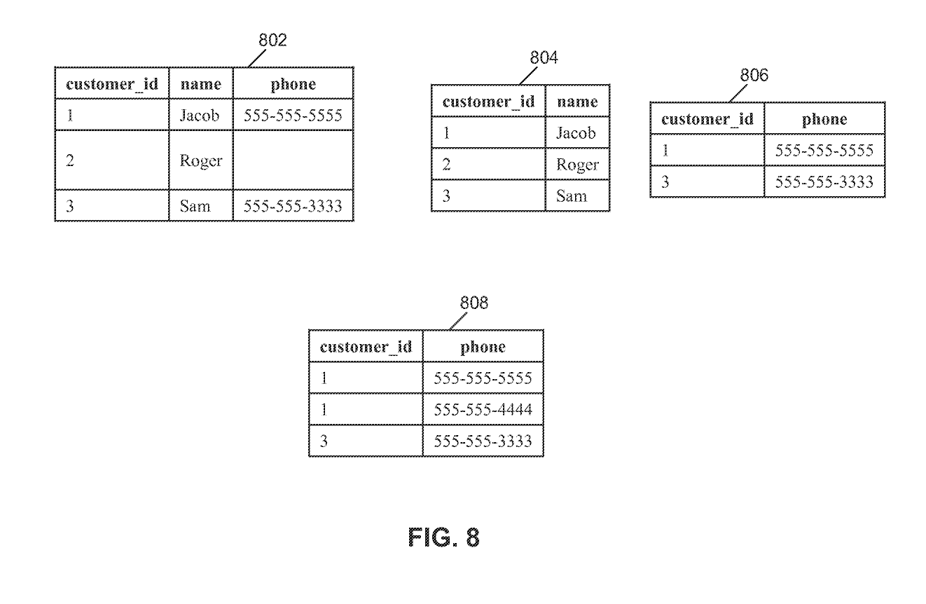

In some embodiments, the new data is structured in a manner substantially equivalent to storing the data in relational tables in which empty column values are substantially minimized. For example, if the result data corresponds to a table such as 802, the data processing and analyzing platform 101 would store the same data as shown in two tables 804 and 806. As can be seen in FIG. 8, whereas table 802 has one empty cell (e.g., a null), neither table 804 and 806 has any empty values. By enforcing this paradigm of storing relational data, embodiments improve scalability and also increase flexibility in accessing the data. Tables 804 and 806 can be joined based upon the customer id to obtain all customers who have a phone number. In the illustrated example, by having separate tables 804 and 806, the scenario of many customers having multiple phone numbers is easily resolved as shown in table 808, rather than adding a second phone number column to table 802 that is likely to be empty for many customers.

Returning to FIG. 2 again, at operation 214, the results produced by the executed data processing queries are provided to the user who submits the data processing query. Providing the results may include displaying the results on the user's CLI interface, or providing the results to the user through some other manner. After operation 214, method 200 may terminate.

However, in other embodiments, method 200, or one or more modules of the data analyzing program initiated in method 200, may remain active in order to monitor the data sources for new data. If new data is detected at the data source, the user may be alerted. The alerting may be based upon a callback function or similar technique. New data may be received, for example, by a crawling operation that detects new data available at an external data source and then transmits such new data to the data processing and analyzing platform to update its local copy of the data. New data may also be available from infinite data streams such as Twitter, blog feeds etc. In some embodiments, data analyzing programs or parts thereof that are active may be utilized by data analyzing programs other than the data analyzing program of the current user. For example, a data collection being acquired as a result of a active program module initiated as part of the data analyzing program deployed by a first user may be used as a data source used by a data analyzing program deployed by a second user.

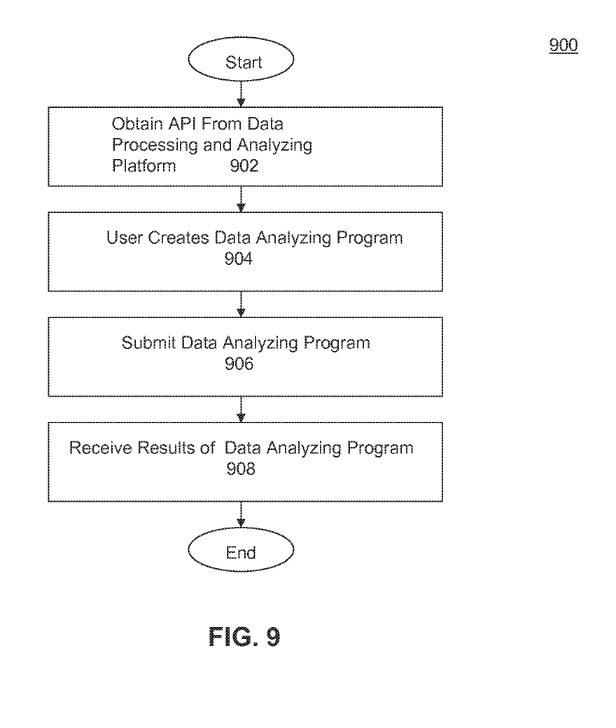

FIG. 9 illustrates a flowchart of a method 900 for a user to structure an information store and perform analyzing, in accordance with one or more embodiments. Operations 902-908 may be performed, for example, by the user device(s) such as client devices 118. It will be understood that operations 902-908 may be performed in the order shown, in an order other than shown, without one or more operations 902-908, or with one or more additional operations.

After entering method 900, at operation 902, the client device obtains the data processing and analyzing platform API from the data processing and analyzing platform. The API, or a portion thereof, may be optionally downloaded to the client device(s) from a storage attached to a server associated with the data processing and analyzing platform. The API may include a CLI, which provides the client device an interface through which the client device can access the data processing and analyzing platform.

At operation 904, the user creates a data analyzing program. The user may create and/or edit the data and control flow to be embodies in the program in an interactive development environment (IDE), text editor, or in some embodiments, in the CLI. In some embodiments, the data analyzing programs are required to confirm to a specified format and programming paradigm. For example, the data analyzing programs may be required to be in the pipe paradigm.

At operation 906, the data analyzing program created by the user is submitted to the data processing and analyzing platform. The data analyzing program may be submitted to the data processing and analyzing platform through the CLI, e.g., by typing “submit_flow” in the command line provided in the CLI as discussed below.

At operation 908, results of the data analyzing program is received by the user, and thereafter method 900 may terminate.

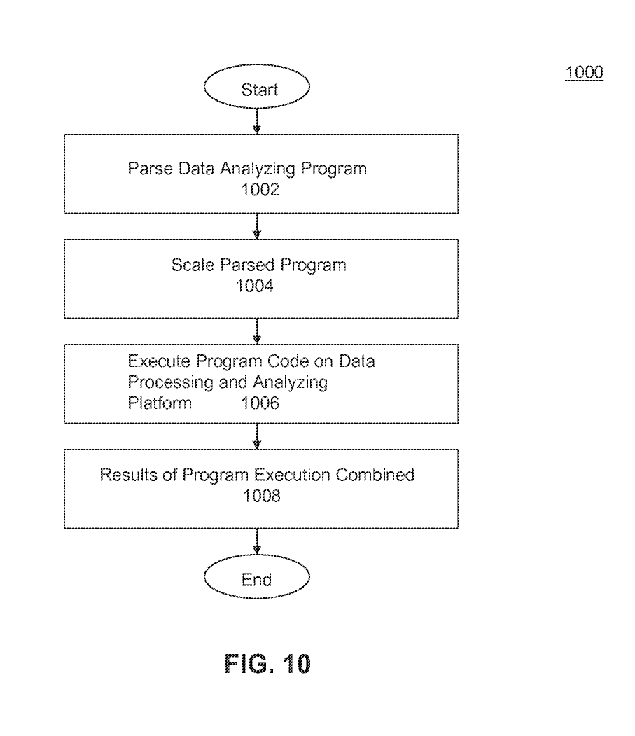

FIG. 10 illustrates a flowchart of a method 1000 for executing the user-provided data analyzing programs in the data processing and analyzing platform, in accordance with one or more embodiments. Operations 1002-1008 may be performed, for example, by the data processing and analyzing platform, when a user-provided data analyzing program is received, such as during operations 206-208 described above. It will be understood that operations 1002-1008 may be performed in the order shown, in an order other than shown, without one or more operations 1002-1008, or with one or more additional operations.

After entering method 1000, at operation 1002 the user-provided data analyzing program is parsed. As noted above, the user may have submitted the data analyzing program in any of several permitted programming and/or scripting languages. The parser at the data processing and analyzing platform may determine one of several translators for generating the corresponding data analyzing programs in a code executable on the data processing and analyzing platform.

At operation 1004, the parser, or an associated scaling component or module, operates to determine a scaling for the user-provided data analyzing program. According to some embodiments, substantial horizontal scaling is achieved by executing the same parts of the data analyzing program with different sets of data at different and/or distributed machines.

The parser generates a parsed data analyzing program or a plurality of parsed data analyzing programs corresponding to the user-provided data analyzing program in a code executable on the data processing and analyzing platform. The code executable on the data processing and analyzing platform may be any one of a high level interpreted and/or compiled language, an intermediate code such as a bytecode, or machine code, or any combination thereof.

At operation 1006, the parsed program is executed on the data processing and analyzing platform. Execution of the parsed program may include distributing the data analyzing program or portions thereof across a plurality of processing nodes (e.g., physical or virtual computers) for execution. For example, the same data analyzing program or portion thereof can be processed at a plurality of processing nodes, with each processing node running the program or part thereof against a defined portion of the data source.

Execution of the data processing queries may include streaming data from one or more data sources to the data analyzing program. The user-provided data analyzing program would specify the data source to be streamed. For example, if the program specifies that web data is streamed, then the data processing and analyzing platform may stream every web-page in its web data corpus, and if the program specifies to stream patents, the data processing and analyzing platform streams from a patent corpus. In some embodiments, all of the data that is streamed to the program are stored locally on the storage servers of the data processing and analyzing platform. For example, in such embodiments, all the data is pre-crawled and stored in the servers. In some embodiments, the pre-stored data may be updated with new incoming data. In some embodiments, data processing and analyzing platform accesses all data provided to the program on its servers, and does not access the web and/or other external data sources “on the fly” to search for data while the query is being processed.

At operation 1008, the results generated by the separate processing nodes are combined in order to form the result for the user-provided query. The combining may be by aggregating the results from the plurality of processing nodes. After operation 1008, method 1000 may terminate.

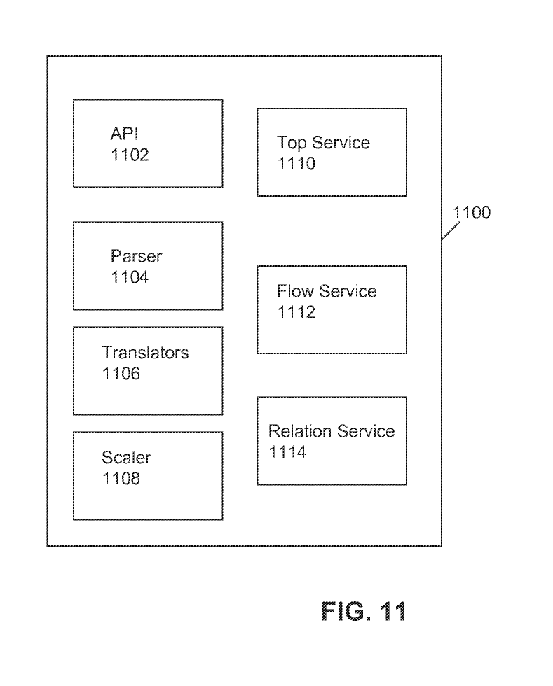

FIG. 11 illustrates some components in a memory 1100 of a computer configured according to an embodiment to operate as a data processing and analyzing platform server 102 and/or data processing query execution node 106.

Memory 1100 includes an instance of the API 112 (identified as 1102 in FIG. 11), a parser 1104, translators 1106, a scaler 1108, a top service component 1110, a flow service component 1112, and a relational service component 1114.

The parser 1104 operates to parse the data analyzing programs received from users. Translators 1106 may include translators for translating the user-provided data analyzing programs from one or more of several permitted user languages (e.g., Ruby, Python, Javascript, SQL, prolog, C++, etc.) to an internal representation. Scaler 1108 operates to decompose and/or duplicate the user queries such that they can be executed on plural machines according to the determined scaling level, and then operates to gather results generated from the plural executions.

Top service component 1110 operates primarily to coordinate the underlying components. Flow service component 1112 is primarily responsible for executing user-provided data analyzing programs. Relational service component 1114 operates to prepare and provide data and input, and also to accept and store incoming new relations.

Top service component 1110 may include a continually running process that watches for commands coming from the API (e.g., api.zillabyte.com). The main one of these commands may be the “submit_flow” command. As the name implies, submit_flow is responsible for actually starting a new data processing query in platform 101. In some embodiments, when a new user-provided data analyzing program is submitted, the top service component passes it in to the flow service component.

The flow service component 1112 is mainly responsible for executing flows. According to an embodiment, the flow service may be built, at least in part, using Storm™. However, other embodiments may use Hadoop/Cascading™ or one of several other big data frameworks. Storm is particularly useful in view of the realtime features of some embodiments.

When a new user-provided data analyzing program is received by the flow service, the spouts (which are further described below) specified in the user-provided data analyzing program are checked. If a spout is a spout_from_relation, then flow service component can request relation service component to prepare a stream of data matching the corresponding “matches” clause included in the corresponding user-provided query. After the data is prepared, flow service component can start streaming that data into the spout, and subsequently into the rest of the flow. Storm may be used for many other aspects (aspects other than spout and sink) of the flow service.

When data starts reaching the sink, the flow service component 1112 will once again communicate with the relation service component 1114 and instruct it to prepare for incoming tuples. In practice, flow service component will batch records together before asking relation service to commit them.

In some embodiments, the relation service component 1114 is a very large relational database. Some embodiments use Amazon Redshift™ as part of the relation service. Amazon Redshift addresses the complexity of scaling this resource horizontally. Relation service offers at least two points of interaction: streaming data out of the service, and streaming data in to the service.

According to an embodiment, when a user-provided data analyzing program requests new data, it will submit a one-time query to Redshift and request it to store the dataset on Amazon S3™ storage platform. From there, the relation service sequentially reads the dataset and streams it into the query.

When a data analyzing program is ready to commit new data to a relation, the flow service batches some predetermined number (e.g., 10,000) of records and serializes them to Amazon S3 storage. Then, it instructs Redshift to read the records directly from S3 storage.

According to some embodiments, memory 1100 may also include one or more data analyzing programs or parts thereof (not shown in FIG. 11). The data analyzing programs or parts may have been previously provided by users during use of the system to obtain to responses to queries. The data analyzing programs or parts may include programs that are currently active and receiving and processing data from sources, and/or programs that are currently not receiving data.

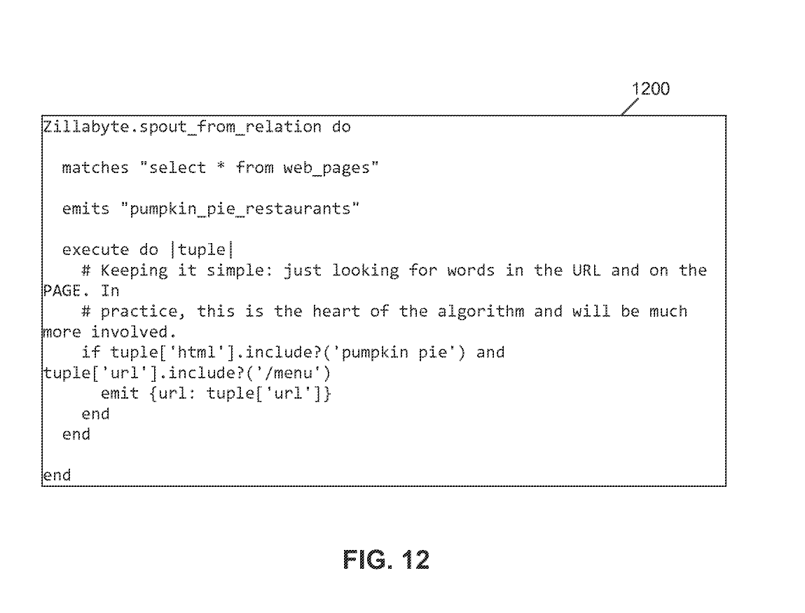

Based on the above, embodiments can scale as needed during runtime rather than being limited to scaling only before the program starts to execute as in conventional data processing and analysis and/or querying systems. Moreover, in embodiments, the machines that process the data may not store the data, and rely upon the network to obtain the data. Still further embodiments provide for using higher level programming languages such as Ruby, Python etc. to develop components which can be then combined in various combinations, rather than being limited to lower level languages such as Java and JVM-based languages. FIG. 12 illustrates an example user-provided data analyzing program 1200, according to an embodiment, that can be used for finding restaurants that sell pumpkin pie. Example data analyzing program 1200 may be, for example as discussed above, the data analyzing program written by the example user who is a developer at a marketing company.

Although, as described above, with conventional search engines, the developer may be unable to accomplish his task (which was described above) without a very large effort, the data processing and analyzing platform 101 provides a user-friendly technique for accomplishing what the developer wants to achieve.

The developer may create data processing query 1200 in the language of his choice (e.g., Ruby, in this case). Because the developer can select from a wide variety of languages in which to construct the user-provided data analyzing program, he can work with tools and/or languages he is already familiar with. Alternatively, the developer may have written this data analyzing program in Python or Javascript—both of which are common staples in modem programming circles. The use of another language other than those mentioned above is possible and is contemplated as embodiments.

While the data processing and analyzing platform 101 yields much freedom to the developer to work in a familiar environment, there may be some restrictions, such as, that the developer is required to follow the “pipe paradigm” programming model when building his data analyzing programs. This restriction may only apply to how the developer's data analyzing program consumes and emits data. Once the developer's data analyzing program has the desired data, the developer may be free to code the actual processing of the data without any substantial restriction.

After the developer has crafted his data analyzing program, he submits it to the data processing and analyzing platform. He can do this after he downloads the data processing and analyzing platform 101 CLI. The CLI may be invoked from his computer's terminal (or Command Prompt in Windows).

An API command such as “zillabyte flows:push” will operate to package the user-provided data analyzing program from the local directory of the user and submit it to the data processing and analyzing platform 101. Once the user-provided data analyzing program is submitted to the data processing and analyzing platform 101, the platform takes over to perform the execution.

The line “matches ‘select * from web_pages’ instructs the data processing and analyzing platform 101 to stream data into the data processing query from the web_pages corpus. The web_pages corpus, as noted above, may be a pre-crawled copy of the web and stored on servers of the data processing and analyzing platform. Since the content is stored, no “web crawling” is necessarily happening at this point.

The matches clause is a regular SQL statement. The developer may be able to filter records at this step by adding a “WHERE” clause (to the SELECT). He can also JOIN with other datasets in the data processing and analyzing platform. A person of skill in the art will appreciate that a high level of flexibility is available within the data processing query to process data according to one or more user-specified criteria or rules.

After the data processing and analyzing platform parses the matches clause, it will start streaming data into the data processing query. Because the data analyzing program is required to process potentially huge amounts of data, the data processing and analyzing platform will automatically scale the data analyzing program. That is, the data processing and analyzing platform will copy the data analyzing program to multiple servers such that each one gets smaller chunks of the web_pages stream. This is advantageous because it will allow the data analyzing program to complete much faster than if it were done on a single machine.

This parallelism is achieved because the data analyzing program adhered to the ‘pipe paradigm’ programming model. If the data processing and analyzing platform did not force this paradigm upon the design of the data analyzing program, then it may not be able to scale automatically.

As the data analyzing program runs, it continually consumes data and emits new data. The emitted data is returned to the data processing and analyzing platform data stores. This data is put into a database table called “pumpkin_pie_restaurants” (as denoted by the emits section). In the developer's case, this table contains only one column ‘url’ having all the urls on the web that are likely restaurants selling pumpkin pies.

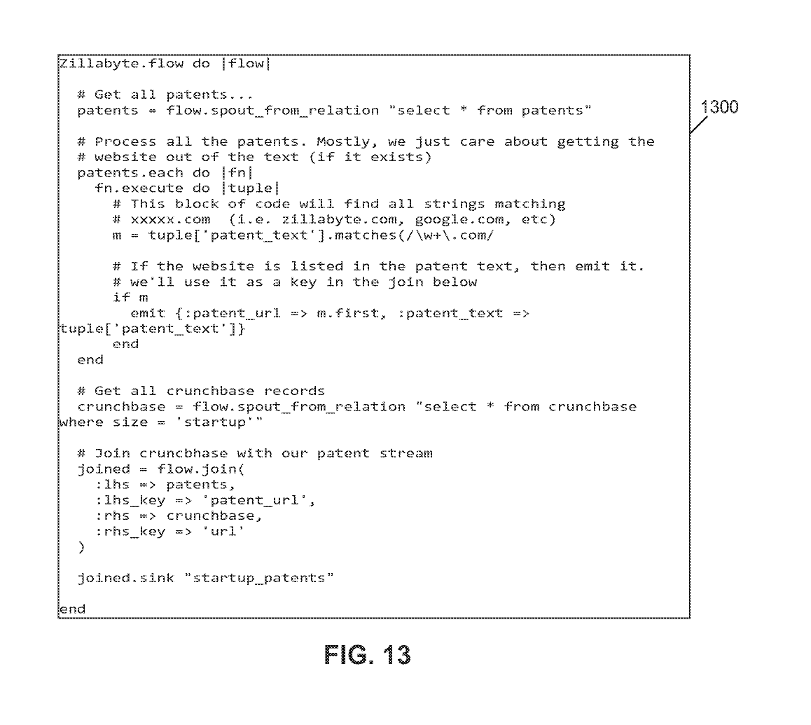

FIG. 13 illustrates an example user-provided data analyzing program 1300, according to an embodiment, that can be used for correlating the information from the web and the patent corpus in order to deliver information requested by the startup company. Example data analyzing program 1300 may be, for example, the data analyzing program written by (or for) the example entrepreneur user described above.

Although, as described above, with conventional search engines, the entrepreneur may be unable to accomplish his task without a large effort, the data processing and analyzing platform 101 can be used to efficiently obtain the desired results.

As described above, conventional search engines do not allow making the associations necessary between the web corpus and another database to obtain the necessary information regarding the company size. The entrepreneur may know that the data processing and analyzing platform has a copy of all patents in its data store, and also a copy of the CrunchBase™ database which has the relevant company information.

Because patents are unstructured blobs of text, the entrepreneur user will be required to do some work so he can “join” the patent corpus with the CrunchBase corpus. In order to do a “join” between these datasets, the entrepreneur needs an appropriate key. In the illustrated example, it is assumed that inside a patent, the website of the submitting company (e.g., zillabyte.com) is listed in the text. The entrepreneur already knows that CrunchBase lists to company's website in its structured records. Crunchbase also captures the size of the company.

This data analyzing program 1300 provides a lot of value in a few lines of code. This first half of data analyzing program 1300 is about taking an unstructured stream of patents, and extracting a key (url) that can be used for joining. In the middle of query 1300, the line “flow.spout_from_relation ‘select * from crunchbase where size=“startup”’” is noted because the fact that Crunchbase is already a structured data source (i.e., it already provides the ‘size’ column, which we can use to filter upfront) can be leveraged. The last part of the data analyzing program 1300 is about joining these two data streams. The join statement here simply says “join the patent stream as the left-hand-side, and use crunchbase as the right-hand-side”.

Like the developer, the entrepreneur can submit data analyzing program 1300 to the data processing and analyzing platform with a simple “zillabyte flows:push” command.

Once data processing data analyzing program 1300 is deployed to data processing and analyzing platform, the following may take place.

The data processing and analyzing platform recognizes that there are two spouts. Like data analyzing program 1200 above, it will start streaming data into the spouts that match the corresponding sql statements. The CrunchBase SQL statement is more interesting because it actually has a condition on it.

It may be noted that if the patent corpus is more structured and provides a column company_url from the start, then this whole exercise would be unnecessary. The entrepreneur could have just run the command zillabyte sql “SELECT * FROM patents, crunchbase where patents.url=crunchbase.url AND crunchbase.size=‘startup’”. But since the patent corpus is not highly structured like that, the entrepreneur is required to perform these additional steps and add his own custom structure.

After the streaming is started to the two spouts, in the flow stream, the data processing and analyzing platform starts to emitting all the raw patent data to the first function in data analyzing program 1300. The first function may simply look for a URL pattern (e.g., any string in the patent text that includes “http” and “.com”). If that string exists, then a new tuple is emitted with the URL in the first position. This value is used below as a join key.

The patent stream is then joined with the CrunchBase stream. It may be important to note that all of this is happening across a large number of servers. The JOIN is accomplished by taking the join-key of the tuples and sending them to the same machines.

Once the streams are joined, they are sunk back into the data processing and analyzing platform as a new relation. In this case, the relation (also referred to as a table) is called “startup_patents”.

After the data processing data analyzing program 1300 is uploaded to the data processing and analyzing platform, it runs until it is explicitly terminated. This aspect allows data analyzing program 1300 to remain active, and as new startups submit patents, update the table (“startup_patents”) such that it continues to grow. The entrepreneur can build a notification system around this and notify his users when new startups submit patents.

It will be appreciated that as used herein, the terms system, subsystem, service, programmed logic circuitry, and the like may be implemented as any suitable combination of software, hardware, firmware, and/or the like. It also will be appreciated that the storage locations herein may be any suitable combination of disk drive devices, memory locations, solid state drives, CD-ROMs, DVDs, tape backups, storage area network (SAN) systems, and/or any other appropriate tangible computer readable storage medium. It also will be appreciated that the techniques described herein may be accomplished by having a processor execute instructions that may be tangibly stored on a computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method, comprising:
providing a data processing and analyzing platform including access to one or more big data sources;
receiving a first data analyzing program submitted by a first user;
executing the first data analyzing program on the data processing and analyzing platform;
adding at least a portion of the first data analyzing program to the data processing and analyzing platform such that the added at least a portion of the first data analyzing program is usable by other users; and
returning a result to the first user as a response to the submitted first data analyzing program.

2. The method according to claim 1, wherein a first data source from the one or more big data sources comprises at least one of raw web data and/or an infinite data stream, and wherein the executing includes accessing the raw web data and/or the infinite data stream.

3. The method according to claim 2, wherein the raw web data in the first data source is acquired by pre-crawling the web, wherein the pre-crawling comprises scraping data from each web page by a web crawler performing said pre-crawling.

4. The method according to claim 2 wherein the first data source comprises a web-scale copy of the web as captured by a plurality of web crawlers.

5. The method according to claim 1, wherein the first user and the second user belong to unrelated administrative domains.

6. The method according to claim 1, further comprising:
receiving a second data analyzing program from one of said other users; and
executing the second data analyzing program on the data processing and analyzing platform, the executing including accessing the added at least a portion of the first data analyzing program.

7. The method according to claim 6, wherein the executing includes automatically, based upon a parsing of the second data analyzing program, forming a data-processing pipeline in which an output of the at least a portion of the first data analyzing program is provided as input to the second data analyzing program.

8. The method according to claim 7, wherein the first data analyzing program and the second data analyzing program are each parsed and executed on plural servers of the data processing and analyzing platform.

9. The method according to claim 1, further comprising:
adding at least a portion of the result to the data processing and analyzing platform as another data source accessible to the other users;
receiving a second data analyzing program from one of the other users; and
executing the second data analyzing program by accessing at least the added another data source.

10. The method according to claim 9, wherein the second data analyzing program includes one or more statements referring to a structure of said another data source, and wherein the structure is in accordance with the first data analyzing program.

11. The method according to claim 9, wherein the added another data source is substantially concurrently being updated by the first data analyzing program.

12. The method according to claim 1, further comprising:
providing an application programming interface (API) for accessing operations of the data processing and analyzing platform, wherein the data analyzing program incorporates at least portions of the API;
configuring the API to include information regarding the one or more data sources; and
configuring the API to display the information regarding the one or more big data sources to users.

13. The method according to claim 1, wherein the executing comprises:
parsing the received first data analyzing program;
generating a plurality of sub-programs based upon the parsed data analyzing program;
scalably executing the plurality of sub-programs across a plurality of computers; and
combining outputs from the sub-programs to generate the result.

14. The method according to claim 1, further comprising:
continuing, based upon changes in the one or more data sources and the received first data analyzing program, to update said big data source after the returning;
monitoring said big data source for updates; and
notifying the first user when the monitoring detects an update.

15. A system, comprising:
a plurality of data sources including one or more big data sources; and
a processing system including at least one processor, the processing system being configured to access said plurality of data sources and further configured to:
provide a data processing and analyzing platform including access to the plurality of data sources;
receive a first data analyzing program submitted by a first user;
execute the first data analyzing program on the data processing and analyzing platform;
adding at least a portion of the first data analyzing program to the data processing and analyzing platform such that the added at least the portion of the first data analyzing program is usable by other users; and
return a result to the first user as a response to the submitted first data analyzing program.

16. The system according to claim 15, wherein the one or more big data sources comprises a raw web data and/or an infinite data stream.

17. The system according to claim 16, wherein the raw web data includes a web-scale crawled copy of the web.

18. The system according to claim 15, further comprising:
receiving a second data analyzing program from one of said other users; and
executing the second data analyzing program on the data processing and analyzing platform, the executing including accessing the added at least a portion of the first data analyzing program.

19. A non-transitory computer readable storage medium having instructions stored thereon that, when executed by a computer, cause the computer to perform operations comprising:
providing a data processing and analyzing platform including access to one or more big data sources;
receiving a first data analyzing program submitted by a first user;
executing the received first data analyzing program on the data processing and analyzing platform;
adding at least a portion of the first data analyzing program to the data processing and analyzing platform such that the added at least a portion of the first data analyzing program is usable by other users; and
returning a result to the first user as a response to the submitted data analyzing program.

20. The computer readable storage medium according to claim 19, wherein the one or more big data sources comprises a web-scale crawled copy of the web and/or an infinite data stream.
